(19) United States
(12) Patent Application Publication
(10) Pub. No.: US 2025/0154325 A1
(43) Pub. Date: May 15, 2025

(54) VANILLIC ACID-BASED ORGANIC-INORGANIC COMPOUND, CURABLE COMPOSITION, AND PRODUCTION METHOD THEREOF

(71) Applicant: Electronics and Telecommunications Research Institute, Daejeon (KR)

(72) Inventors: GWANG-MUN CHOI, Daejeon (KR); Yong-Sung EOM, Daejeon (KR); Jiho JOO, Daejeon (KR); KWANG-SEONG CHOI, Daejeon (KR); Seok-Hwan MOON, Daejeon (KR); Jungho SHIN, Daejeon (KR); Jin-Hyuk OH, Daejeon (KR); CHANMI LEE, Daejeon (KR); Ki-Seok JANG, Daejeon (KR)

(73) Assignee: Electronics and Telecommunications Research Institute, Daejeon (KR)

(21) Appl. No.: 18/943,377

(22) Filed: Nov. 11, 2024

(30) Foreign Application Priority Data
Nov. 13, 2023 (KR) 10-2023-0156683
Oct. 15, 2024 (KR) 10-2024-0140663

(51) Int. Cl. C08G 77/52; B01J 31/08

(52) U.S. Cl. CPC C08G 77/52; B01J 31/08

(57) ABSTRACT

Provided is an organic-inorganic compound, and the organic-inorganic compound contains a curable reactive group and includes a structure represented by Formula 1 below:

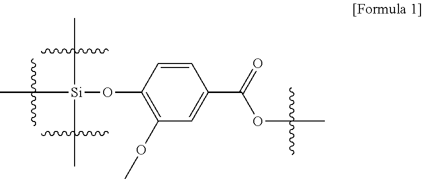 [SMILES: *OC(=O)c1ccc(O[Si](*)(*)*)c(OC)c1]

### CROSS-REFERENCE TO RELATED APPLICATIONS

This U.S. non-provisional patent application claims priority under 35 U.S.C. § 119 of Korean Patent Application No. 10-2023-0156683, filed on Nov. 13, 2023 and Korean Patent Application No. 10-2024-0140663, filed on Oct. 15, 2024, the entire contents of which are hereby incorporated by reference.

### BACKGROUND

The present disclosure herein relates to a vanillic acid-based organic-inorganic compound containing a curable reactive group, a silyl ether bond, and a silyl ester bond, a curable composition, and a production method thereof.

As demand for low carbon and environmental friendliness increases more and more for climate change response and sustainable growth, efforts are being actively made to replace existing petroleum-based plastics with bio-based plastics. However, although bio-based plastics that are concurrently being implemented satisfy the requirements for low carbon and environmental friendliness, there is such a limitation that the bio-based plastics cannot achieve significantly excellent characteristics as compared with existing petrochemical-based plastics, which makes it difficult to apply the bio-based plastics to the fields of advanced materials for displays, semiconductors, and the like.

### SUMMARY

The present disclosure provides a vanillic acid-based organic-inorganic compound having a curable reactive group, a silyl ether bond, and a silyl ester bond, and a curable composition containing the same.

The present disclosure also provides a production method of a vanillic acid-based organic-inorganic compound having a curable reactive group, a silyl ether bond, and a silyl ester bond.

An embodiment of the inventive concept provides an organic-inorganic compound containing a curable reactive group and including a structure represented by Formula 1.

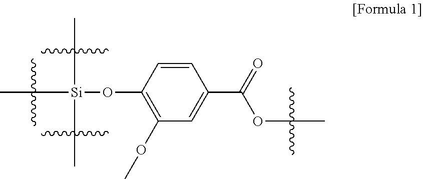 [SMILES: *OC(=O)c1ccc(O[Si](*)(*)*)c(OC)c1]

In an embodiment, Formula 1 above may be Formula 2.

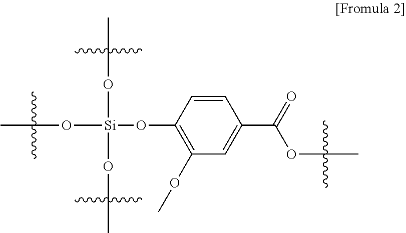

In an embodiment, Formula of the organic-inorganic compound may further include Formula 3.

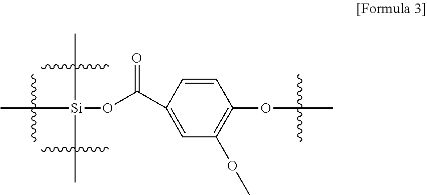 [SMILES: *Oc1ccc(C(=O)O[Si](*)(*)*)cc1OC]

In an embodiment, Formula 3 above may be Formula 4 below.

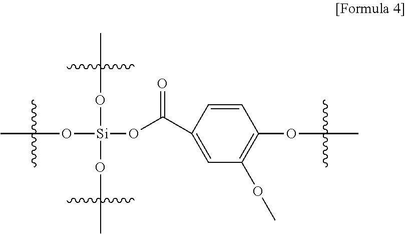 [SMILES: *Oc1ccc(C(=O)O[Si](O*)(O*)O*)cc1OC]

In an embodiment, Formula of the organic-inorganic compound may further include a repeating unit represented by Formula 5 below.

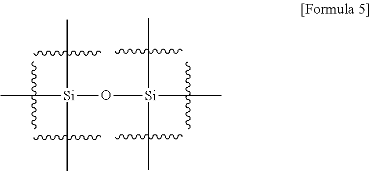

In an embodiment, the organic-inorganic compound may further include at least one of a group consisting of a compound represented by Formula 6 below and a compound represented by Formula 7 below.

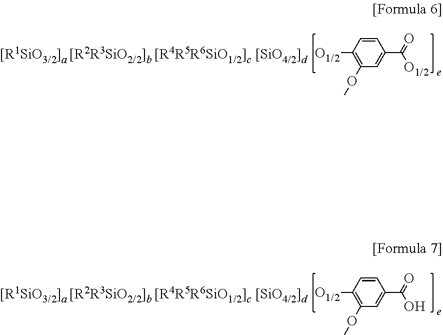

In Formula 6 and Formula 7 above, a, b, c, and d may be each independently 0 or a positive number, where at least one of a, b, or c may be a positive number, e may be a positive number, R¹, R², R³, R⁴, R⁵, and R⁶ may be each independently selected from the group consisting of the curable reactive group, a C, to C₂₀ alkyl group, a C₃ to C₈ cycloalkyl group, and a C₆ to C₂₀ aryl group, and at least one of R¹, R², R³, R⁴, R⁵, or R⁶ may include the curable reactive group.

In an embodiment, the organic-inorganic compound may further include a compound represented by Formula 8 below.

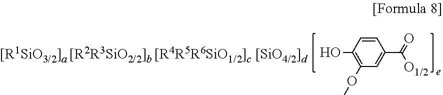

In Formula 8, a, b, c, and d may be each independently 0 or a positive number, where at least one of a, b, or c may be a positive number, e may be a positive number, R¹, R², R³, R⁴, R⁵, and R⁶ may be each independently selected from the group consisting of the curable reactive group, a C₁ to C₂₀ alkyl group, a C₃ to C₈ cycloalkyl group, and a C₆ to C₂₀ aryl group, and at least one of R¹, R², R³, R⁴, R⁵, or R⁶ may include the curable reactive group.

In an embodiment, Formula 6, Formula 7, and Formula 8 above may each independently satisfy Expression 1 to Expression 3 below.

$$0.3 \leq a + b + c + d \leq 0.7 \qquad [ Expression 1 ]$$

$$0.3 \leq e \leq 0.7 \qquad [ Expression 2 ]$$

$$a + b + c + d + e = 1 . \qquad [ Expression 3 ]$$

In an embodiment, the curable reactive group may include any one or more from the group consisting of an epoxy group, an amine group, an acrylic group, a methacrylic group, a mercapto group, a carboxylic group, a vinyl group, a nitro group, a sulfone group, a hydroxy group, a urethane group, a ureide group, an isocyanate group, an oxetane group, or combinations thereof.

In an embodiment of the inventive concept, a production method of an organic-inorganic compound includes preparing a silane compound containing a curable reactive group; preparing vanillic acid; and reacting the silane compound with the vanillic acid to form a repeating unit represented by Formula 1 below.

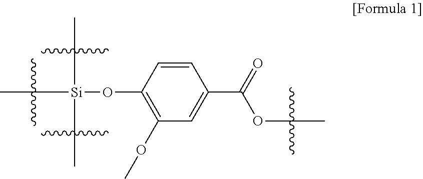

In an embodiment, the silane compound may include any one or more selected from the group consisting of Formula 9 to Formula 11 below.

R¹Si(OR^{I})₃ [Formula 9]

R²R³Si(OR^{II})₂ [Formula 10]

R⁴R⁵R⁶Si(OR^{III}) [Formula 11]

In Formula 9 and Formula 11 above, R¹, R², R³, R⁴, R⁵, and R⁶ may be each independently selected from the group consisting of the curable reactive group, a C, to C₂₀ alkyl group, a C₃ to C₈ cycloalkyl group, or a C₆ to C₂₀ aryl group, at least one of R¹, R², R³, R⁴, R⁵, or R⁶ may include the curable reactive group, and R^{I}, R^{II}, and R^{III} may each independently include hydrogen or a C₁ to C₆ alkyl group.

In an embodiment, the forming of the repeating unit represented by Formula 1 above may include reacting the silane compound with the vanillic acid at a molar ratio of about 1:2.3 to about 2.3:1

In an embodiment, the silane compound may include any one or more in the group consisting of 5,6-epoxyhexyltriethoxysilane, 3-glycidoxypropyltrimethoxysilane, 3-glycidoxypropyltriethoxysilane, 2-(3,4-epoxycyclohexyl)ethyltrimethoxysilane, 2-(3,4-epoxycyclohexyl)ethyltriethoxysilane, 3-ethyl-3-[[3-(triethoxysilyl)propoxy]methyl]oxetane, 7-trimethoxysilyl-4-thia-heptanoic acid-(3-ethyl-oxetan-3-yl)methyl ester, N-(3-triethoxysilylpropyl)-(3-ethyloxetan-3-yl)-methyl carbamate, 2-(3-triethoxysilylpropylthio)succinic acid-bis-[(3-ethyloxetane-3-yl)-methyl]ester, (3,4-epoxycyclohexyl)ethyldimethoxysilane, 2-(3,4-epoxycyclohexyl)ethyl(methyl)dimethoxysilane, (3,4-epoxycyclohexyl)ethyldiethoxysilane, 2-(3,4-epoxycyclohexyl)ethyl(methyl)diethoxysilane, (2-(7-oxabicyclo[4.1.0]heptan-3-yl)ethyl)(methyl)silanediol, dimethoxy(methyl)(3-(oxiran-2-yl)propyl)silane, diethoxy(methyl)(3-(oxiran-2-yl)propyl)silane, methyl(3-(oxiran-2-yl)propyl)silanediol, (3-glycidoxypropyl)dimethoxymethylsilane, (3-glycidoxypropyl)diethoxymethylsilane, (3-glycidoxypropyl)methylsilanediol, (3-glycidoxypropyl)dimethylethoxysilane, and 3-glycidoxypropyldimethylmethoxysilane.

In an embodiment, the silane compound may include any one or more in the group consisting of 4-aminobutyltriethoxysilane, 4-amino-3,3-dimethylbutyltrimethoxysilane, N-(2-aminoethyl)-3-aminopropyltrimethoxysilane, N-(6-aminohexyl)aminomethyltriethoxysilane, N-(6-aminohexyl)aminopropyltrimethoxysilane, n-(2-aminoethyl)-11-aminoundecyltrimethoxysilane, N-(2-aminoethyl)-3-aminopropylsilanetriol, 3-aminopropyltrimethoxysilane, 3-aminopropyltriethoxysilane, 3-triethoxysilyl-N-(1,3 dimethyl-butylidene) propylamine, N-phenyl-3-aminopropyltrimethoxysilane, N-(vinylbenzyl)-2-aminoethyl-3-aminopropyltrimethoxysilane hydrochloride, 3-(m-aminophenoxy)propyltrimethoxysilane, m-aminophenyltrimethoxysilane, p-aminophenyltrimethoxysilane, aminophenyltrimethoxysilane, 3-aminopropyltris(methoxyethoxyethoxy)silane, 11-aminoundecyltriethoxysilane, 2-(4-pyridylethyl)triethoxysilane, 2-(2-pyridylethyl)trimethoxysilane, N-(3-trimethoxysilylpropyl)pyrrole, 3-aminopropylsilanetriol, (aminoethylaminomethyl)phenethyltrimethoxysilane, 3-ureidopropyltrialkoxysilane, 3-isocyanatepropyltriethoxysilane, 3-mercaptopropyltrimethoxysilane, N-2-(aminoethyl)-3-aminopropylmethyldimethoxysilane, N-(2-aminoethyl)-3-aminopropylmethyldiethoxysilane, N-(2-aminoethyl)-3-aminoisobutylmethyldimethoxysilane, 4-amino-3,3-dimethylbutylmethyldimethoxysilane, 3-aminopropylmethyldiethoxysilane, 3-mercaptopropylmethyldimethoxysilane, 1-amino-2-(dimethylethoxysilyl)propane, 3-aminopropyldiisopropylethoxysilane, 3-aminopropyldimethylethoxysilane, and N-(2-aminoethyl)-3-aminoisobutyldimethylmethoxysilane.

In an embodiment, the forming of the repeating unit represented by Formula 1 above may include mixing the silane compound and the vanillic acid to form a mixture and mixing a catalyst into the mixture. The catalyst may include any one or more from the group consisting of an acidic catalyst, a basic catalyst, an ion exchange resin and water, the acidic catalyst may include any one or more from the group consisting of acetic acid, hydrochloric acid, hydrogen fluoride, sulfuric acid, nitric acid, chlorosulfonic acid, iodic acid, and pyrophosphoric acid, and the basic catalyst includes any one or more selected from the group consisting of potassium hydroxide, sodium hydroxide, barium hydroxide, and imidazole.

In an embodiment, the catalyst may be an ion exchange resin including a structure represented by Formula 13 below.

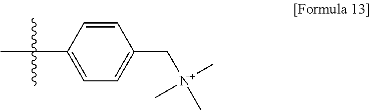 [SMILES: *c1ccc(C[N+](C)(C)C)cc1]

In an embodiment of the inventive concept, a curable composition contains an organic-inorganic compound including a curable reactive group and including a structure represented by Formula 1 below, and a curing agent. The curing agent may include any one or more from the group consisting of an acid anhydride-based curing agent, an amine-based curing agent, an imidazole-based curing agent, a carboxylic acid-based curing agent, a phosphine-based curing agent, and a urea derivative-based curing agent.

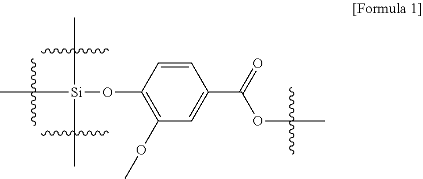 [SMILES: *OC(=O)c1ccc(O[Si](*)(*)*)c(OC)c1]

In an embodiment, the curable composition may further contain an initiator. The initiator may include any one or more from the group consisting of a photoacid generator, a photobase generator, and a thermal acid generator.

In an embodiment, the curable composition may further contain a reactive diluent. The reactive diluent may include any one or more from the group consisting of an epoxy reactive diluent, an oxetane reactive diluent, and polyethylene glycol.

In an embodiment, the curable composition may further contain an additive. The additive may include any one or more from the group consisting of a carbon nanotube, a fullerene, hexagonal boron nitride, a boron nitride nanotube, alumina, a metal particle, a solder particle, and MXene.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept.

In the drawings:

FIG. 1 shows results obtained by carrying out a ²⁹Si-nuclear magnetic resonance (NMR) analysis in <Example>,

FIG. 2A to FIG. 2C show results of experiments according to <Experimental Example 1>in <Example 1>,

FIG. 3 shows results of an experiment according to <Experimental Example 2>in <Example 1>,

FIG. 4A to FIG. 4B show results of experiments according to <Experimental Example 3>in <Example 2>; and

FIG. 5 shows results of an experiment according to <Experimental Example 3>in <Example 3>.

### DETAILED DESCRIPTION

In order to allow the configuration and effects of the present invention to be to fully understand, preferred embodiments of the inventive concept are described with reference to the attached drawings. However, the present invention is not limited to the embodiments described below but can be implemented in various forms, and various modifications can be made. Rather, these embodiments are provided so that the disclose of the present invention will be thorough and complete and will fully convey the scope of the invention to those skilled in the art. In the accompanying drawings, the constitutional elements are shown at a larger size than the actual size thereof are for the convenience of description, and the ratio of each constitutional element may be exaggerated or reduced.

### [Vanillic Acid-Based Organic-Inorganic Compound]

An organic-inorganic compound according to an embodiment of the inventive concept may contain a curable reactive group and may include a structure represented by Formula 1 below.

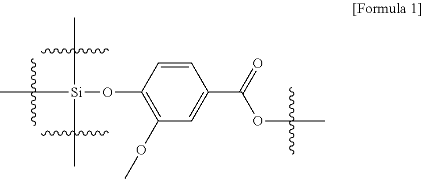 [SMILES: *OC(=O)c1ccc(O[Si](*)(*)*)c(OC)c1]

The curable reactive group may include any one or more from the group consisting of an epoxy group, an amine group, an acrylic group, a methacrylic group, a mercapto group, a carboxylic group, a vinyl group, a nitro group, a sulfone group, a hydroxy group, a urethane group, a ureide group, an isocyanate group, an oxetane group, and combinations thereof.

The curable reactive group may be, for example, an epoxy group and/or an oxetane group. The curable reactive group may be, for example, an epoxy group.

Formula 1 above may be Formula 2 below.

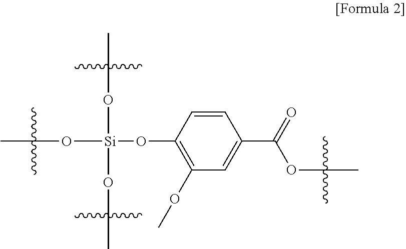

The Formula of the organic-inorganic compound may further include Formula 3 below.

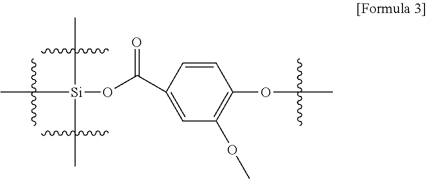 [SMILES: *Oc1ccc(C(=O)O[Si](*)(*)*)cc1OC]

Formula 3 above may be Formula 4 below.

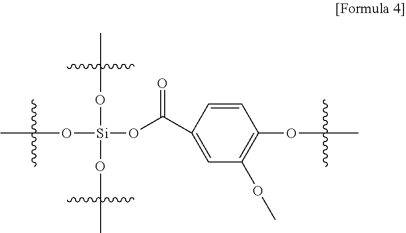 [SMILES: *Oc1ccc(C(=O)O[Si](O*)(O*)O*)cc1OC]

The Formula of the organic-inorganic compound may further include a repeating unit represented by Formula 5 below.

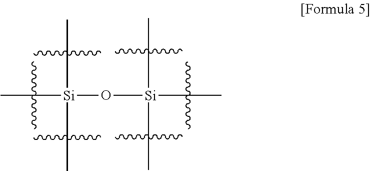

The organic-inorganic compound may further include at least one in the group consisting of a compound represented by Formula 6 below and a compound represented by Formula 7 below.

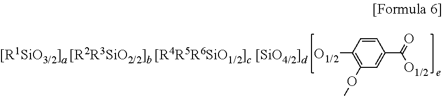

In Formula 6 above,
a, b, c, and d are each independently 0 or a positive number,
where at least one of a, b, or c is a positive number,
e is a positive number,

R¹, R², R³, R⁴, R⁵, and R⁶ are each independently selected from the group consisting of the curable reactive group, a C₁ to C₂₀ alkyl group, a C₃ to C₈ cycloalkyl group, and a C₆ to C₂₀ aryl group, and
at least one of R¹, R², R³, R⁴, R⁵, or R⁶ includes the curable reactive group.

In Formula 6 above, a, b, c, d, and e may satisfy Expression 1 to Expression 3 below.

$$0.3 \leq a + b + c + d \leq 0.7 \qquad [ Expression 1 ]$$

$$0.3 \leq e \leq 0.7 \qquad [ Expression 2 ]$$

$$a + b + c + d + e = 1 \qquad [ Expression 3 ]$$

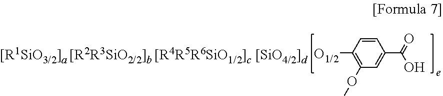

In [Formula 7] above,
a, b, c, and d are each independently 0 or a positive number,
where at least one of a, b, or c is a positive number,
e is a positive number,
R¹, R², R³, R⁴, R⁵, and R⁶ are each independently selected from the group consisting of the curable reactive group, a C₁ to C₂₀ alkyl group, a C₃ to C₈ cycloalkyl group, and a C₆ to C₂₀ aryl group, and
at least one of R¹, R², R³, R⁴, R⁵, and R⁶includes the curable reactive group.

In Formula above, a, b, c, d, and e may satisfy Expression 1 to Expression 3 below.

$$0.3 \leq a + b + c + d \leq 0.7 \qquad [ Expression 1 ]$$

$$0.3 \leq e \leq 0.7 \qquad [ Expression 2 ]$$

$$a + b + c + d + e = 1 \qquad [ Expression 3 ]$$

The organic-inorganic compound may further include a compound represented by Formula 8 below.

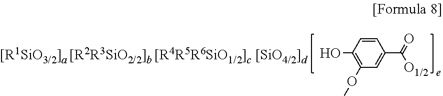

In Formula 8 above,
a, b, c, and d are each independently 0 or a positive number,
where at least one of a, b, or c is a positive number,
e is a positive number,
R¹, R², R³, R⁴, R⁵, and R⁶ are each independently selected from the group consisting of the curable reactive group, a C₁ to C₂₀ alkyl group, a C₃ to C₈ cycloalkyl group, and a C₆ to C₂₀ aryl group, and
at least one of R¹, R², R³, R⁴, R⁵, or R⁶ includes the curable reactive group.

In Formula 8 above, a, b, c, d, and e may satisfy Expression 1 to Expression 3 below.

$$0.3 \leq a + b + c + d \leq 0.7 \qquad [ Expression 1 ]$$

$$0.3 \leq e \leq 0.7 \qquad [ Expression 2 ]$$

$$a + b + c + d + e = 1 \qquad [ Expression 3 ]$$

### [Vanillic Acid-Based Curable Composition]

A curable composition according to an embodiment of the inventive concept may include an organic-inorganic compound and a curing agent.

The organic-inorganic compound may contain a curable reactive group and may include a structure represented by Formula 1 below.

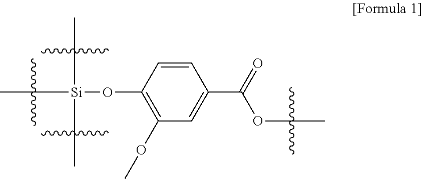 [SMILES: *OC(=O)c1ccc(O[Si](*)(*)*)c(OC)c1]

The curable reactive group may include any one or more from the group consisting of an epoxy group, an amine group, an acrylic group, a methacrylic group, a mercapto group, a carboxylic group, a vinyl group, a nitro group, a sulfone group, a hydroxy group, a urethane group, a ureide group, an isocyanate group, an oxetane group, and combinations thereof.

The curing agent may include any one or more from the group consisting of an acid anhydride-based curing agent, an amine-based curing agent, an imidazole-based curing agent, a carboxylic acid-based curing agent, a phosphine-based curing agent, and a urea derivative curing agent.

For example, the acid anhydride-based curing agent may include any one or more in the group consisting of a phthalic anhydride, a trimellitic anhydride, a pyromellitic dianhydride, a benzophenone tetracarboxylic dianhydride, a maleic anhydride, a tetrahydrophthalic anhydride, methyltetrahydrophthalic anhydride, endomethylene tetrahydrophthalic anhydride, methylendothylenetetrahydrophthalic anhydride, methylbutenyltetrahydrophthalic anhydride, dodecenylsuccinic anhydride, hexahydrophthalic anhydride, methylhexahydrophthalic anhydride, succinic anhydride, methylcyclohexene dicarboxylic anhydride, a chlorendic anhydride, a combination thereof, and a chemical reactant thereof.

For example, the amine-based curing agent may include any one or more in the group consisting of diethylenetriamine, triethylenediamine, triethylenetetraamine, tetraethylenepentamine, diethylaminopropyleneamine, aminoethyl piperazine, menthanediamine, isopronediamine, metaphenylenediamine, diaminodiphenyl methane, diaminodiphenyl sulfone, 2-methyl-4-nitroaniline, dicyandiamide, triethylamine, benzyldimethylamine, methylbenzyldimethylamine, 2-(dimethylaminomethyl)phenol, 2,4,6-tris(dimethylaminomethyl)phenol, 1,8-diazabicyclo[5,4,0]undec-7-ene, 1,5-diazabicyclo[4.3.0]non-5-ene, a boron trichloride, a boron trifluoride, a combination thereof, and a chemical reactant thereof.

For example, the imidazole curing agent may include any one or more in the group consisting of 2-methylimidazole, 2-ethyl-4-methylimidazole, 2,4-dimethylimidazole, 2-phenylimidazole, 2-phenyl-4-methylimidazole, 1-cyanoethyl-2-undecylimidazolium trimelitate, an epoxy imidazole adduct, a microencapsulated potential curing agent having a shape in which a core is made of an imidazole-based substance and a surface of the core is coated with a polymer-based substance, a combination thereof, and a chemical reactant thereof.

For example, the carboxylic acid curing agent may include any one or more in the group consisting of an alpha (a)-amino acid, a beta (beta)-amino acid, a gamma (γ)-amino acid, a delta (delta)-amino acid, anthranilic acid, 3-aminobenzoic acid, para-aminobenzoic acid, and a combination thereof.

For example, the carboxylic acid curing agent may include any one or more in the group consisting of: carboxylic acids such as glycine, alanine, valine, leucine, isoleucine, lysine, arginine, histidine, aspartic acid, asparagine, glutamine, phenylalanine, tyrosine, tryptophan, cysteine, methionine, serine, ornithine, 3-phenylserine, threonine, L-dopa, norleucine, penicillamine, sarcosine, proline, hydroxyproline, 3-hydroxyproline, 3,4-dihydroproline, pipecolic acid, beta-alanine, 3-aminobutyric acid, isoserine, 3-aminoisobutyric acid, 3-amino-2-phenylpropionic acid, 3-amino-5-methylhexanoic acid, 3-amino-4-hydroxybutyric acid, 3-amino-4-hydroxybutyric acid, 3-amino-4-hydroxypentanoic acid, 3-amino-4-methylpentanoic acid, 3-amino-3-phenylpropionic acid, pyrrolidine-3-carboxylic acid, y-aminobutyric acid, 4-amino-3-hydroxybutyric acid, 3-pyrrolidin-2-yl-propionic acid, 3-aminocyclohexanecarboxylic acid, 4-guanidinobutyric acid, 4-aminobenzoic acid, 3-aminobenzoic acid, 2-aminobenzoic acid, 3,5-diaminobenzoic acid, 4-aminosalicylic acid, 5-aminosalicylic acid, 3-aminoisonicotinic acid, 4-aminonicotinic acid, 5-aminonicotinic acid, 2-aminonicotinic acid, 6-aminonicotinic acid, 2-aminoisonicotinic acid, 6-aminopicolinic acid, formic acid, acetic acid, propionic acid, butyric acid, valeric acid, caproic acid, capric acid, decanoic acid, lauric acid, myristic acid, palmitic acid, stearic acid, oleic acid, linoleic acid, alpha-linolenic acid, cyclohexanecarboxylic acid, phenylacetic acid, benzoic acid, chlorobenzoic acid, bromobenzoic acid, nitrobenzoic acid, phthalic acid, isophthalic acid, terephthalic acid, salicylic acid, hydroxybenzoic acid, anthranilic acid, aminobenzoic acid, methoxybenzoic acid, glutaric acid, maleic acid, azelaic acid, abietic acid, adipic acid, ascorbic acid, acrylic acid, and citric acid; a combination thereof; and a chemical reactant thereof.

The curable composition may further contain an initiator. The initiator may include any one or more from the group consisting of a photoacid generator, a photobase generator, and a thermal acid generator.

For example, the initiator may include any one or more in the group consisting of a ytterbium trifluoromethanesulfonate salt, a samarium trifluoromethanesulfonate salt, an erbium trifluoromethanesulfonate salt, a lanthanum trifluoromethanesulfonate salt, a tetrabutylphosphonium methanesulfonate salt, an ethyltriphenylphosphonium bromide salt, a 3-methyl-2-butenyltetramethylenesulfonium hexafluoroantimonate salt, a triarylsulfonium hexafluoroantimonate salt, a triarylsulfonium hexafluorophosphate salt, a 9-(4-hydroxyethoxyphenyl)thianthrenium hexafluorophosphate salt, a 1-(3-methylbut-2-enyl)tetrahydro-1 H-thiophenium hexafluoroantimonate salt, a diphenyliodonium hexafluoroantimonate salt, a diphenyliodonium hexafluorophosphate salt, a ditolyliodonium hexafluorophosphate salt, a triflic acid salt, a combination thereof, and a chemical reactant thereof.

The curable composition may further contain a reactive diluent. The reactive diluent may include any one or more from the group consisting of an epoxy reactive diluent, an oxetane reactive diluent, and polyethylene glycol.

For example, the epoxy reactive diluent may include any one or more in the group consisting of 2-ethylhexyl glycidyl ether, allyl glycidyl ether, polypropylene glycol glycidyl ether-H, polypropylene glycol glycidyl ether-S, n-butyl glycidyl ether, phenyl glycidyl ether, 4-vinylcyclohexene dioxide, cyclohexene vinyl monoxide, (3,4-epoxycyclohexyl)methyl 3,4-epoxycyclohexylcarboxylate, 3,4-epoxycyclohexylmethyl methacrylate, 3,4-epoxycyclohexanecarboxylate, 2-(3,4-epoxycyclohexyl)-1,3-dioxolane, bis(3,4-epoxycyclohexylmethyl)adipate, a combination thereof, and a chemical reactant thereof.

For example, the oxetane reactive diluent may include any one or more in the group consisting of 3-methyloxetane, 2-methyloxetane, 3-oxetanol, 2-methyleneoxetane, 3-methyl-3-hydroxymethyloxetane, 3-ethyl-3-hydroxymethyloxetane, 3,3-oxetanedimethane thiol, 2-ethylhexyl oxetane, 4-(3-methyloxetane-3-yl)benzonitrile, N-(2,2-dimethylpropyl)-3-methyl-3-oxetanemethanamine, N-(1,2-dimethylbutyl)-3-methyl-3-oxetanennethanannine, xylylene bisoxetane, and 3-ethyl-3[{(3-ethyloxetane-3-yl)methoxy}methyl]oxetane, (3-ethyloxetane-3-yl)methyl (meth)acrylate, 4-[(3-ethyloxetane-3-yl)methoxy]butan-1-ol, a combination thereof, and a chemical reactant thereof.

The curable composition may further contain an additive. The additive may include any one or more from the group consisting of a carbon nanotube, a fullerene, hexagonal boron nitride, a boron nitride nanotube, alumina, a metal particle, a solder particle, and MXene.

### [Production Method of Vanillic Acid-Based Organic-Inorganic Compound]

A production method of an organic-inorganic compound according to an embodiment of the inventive concept may include: preparing a silane compound containing a curable reactive group; preparing vanillic acid; and reacting the silane compound and the vanillic acid to form a repeating unit represented by Formula 1 below.

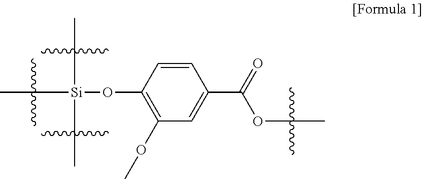

The silane compound may include any one or more selected from the group consisting of Formula 9 below to Formula 11 below.

R¹Si(OR^{I})₃ [Formula 9]

R²R³Si(OR^{II})₂ [Formula 10]

R⁴R⁵R⁶Si(OR^{III}) [Formula 11]

In Formula 9 above and Formula 11 above,
R¹, R², R³, R⁴, R⁵, and R⁶ are each independently selected from the group consisting of the curable reactive group, a C₁ to C₂₀ alkyl group, a C₃ to C₈ cycloalkyl group, and a C₆ to C₂₀ aryl group,
at least one of R¹, R², R³, R⁴, R⁵, or R⁶ includes the curable reactive group, and
R^{I}, R^{II}, and R^{III} each independently include hydrogen or a C₁ to C₆ alkyl group.

For example, the forming of the repeating unit represented by Formula 1 above may include reacting the silane compound and the vanillic acid at a molar ratio of about 1:2.3 to about 2.3:1. For example, the molar ratio of the vanillic acid reacted to the silane compound reacted may be about 1:2.3, about 1:2.2, about 1:2.1, about 1:2, about 1:1.9, about 1:1.8, about 1:1.7, about 1:1.6, about 1:1.5, about 1:1.4, about 1:1.3, about 1:1.2, about 1:1.1, about 1:1, about 1:1.1, about 1.2:1, about 1.3:1, about 1.4:1, about 1.5:1, about 1.6:1, about 1.7:1, about 1.8:1, about 1.9:1, about 2:1, about 2.1:1, about 2.2:1, or about 2.3:1. For example, the molar ratio of the vanillic acid reacted to the silane compound reacted may be about 2:3, about 1:1, or about 3:2.

For example, in a case where the silane compound includes Formula 9 above and the curable reactive group is an epoxy group and/or an oxetane group, the silane compound may include any one or more in the group consisting of 5,6-epoxyhexyltriethoxysilane, 3-glycidoxypropyltrimethoxysilane, 3-glycidoxypropyltriethoxysilane, 2-(3,4-epoxycyclohexyl)ethyltrimethoxysilane, 2-(3,4-epoxycyclohexyl)ethyltriethoxysilane, 3-ethyl-3-[[3-(triethoxysilyl)propoxy]methyl]oxetane, 7-trimethoxysilyl-4-thia-heptanoic acid-(3-ethyl-oxetan-3-yl)methyl ester, N-(3-triethoxysilylpropyl)-(3-ethyloxetan-3-yl)-methyl carbamate, and 2-(3-triethoxysilylpropylthio)succinic acid-bis-[(3-ethyloxetane-3-yl)-methyl]ester.

For example, in a case where the silane compound includes Formula 10 above and the curable reactive group is an epoxy group and/or an oxetane group, the silane compound may include any one or more in the group consisting of (3,4-epoxycyclohexyl)ethyldimethoxysilane, 2-(3,4-epoxycyclohexyl)ethyl(methyl)dimethoxysilane, (3,4-epoxycyclohexyl)ethyldiethoxysilane, 2-(3,4-epoxycyclohexyl)ethyl(methyl)diethoxysilane, (2-(7-oxabicyclo[4.1.0]heptan-3-yl)ethyl)(methyl)silanediol, dimethoxy(methyl)(3-(oxiran-2-yl)propyl)silane, diethoxy(methyl)(3-(oxiran-2-yl)propyl)silane, methyl(3-(oxiran-2-yl)propyl)silanediol, (3-glycidoxypropyl)dimethoxymethylsilane, (3-glycidoxypropyl)diethoxymethylsilane, and (3-glycidoxypropyl)methylsilanediol.

As an example, in a case where the silane compound includes [Formula 11] and the curable reactive group is an epoxy group and/or an oxetane group, the silane compound may include any one or more in the group consisting of (3-glycidoxypropyl)dimethylethoxysilane, and 3-glycidoxypropyldimethylmethoxysilane.

For example, in a case where the silane compound includes Formula 11 above and the curable reactive group is an epoxy group and/or an oxetane group, the silane compound may include any one or more in the group consisting of (3-glycidoxypropyl)dimethylethoxysilane, and 3-glycidoxypropyldimethylmethoxysilane.

For example, in a case where the silane compound includes Formula 9 above and the curable reactive group includes any one or more in the group consisting of an amine group, a ureide group, and an isocyanate group, the silane compound may include any one or more in the group consisting of 4-aminobutyltriethoxysilane, 4-amino-3,3-dimethylbutyltrimethoxysilane, N-2-(aminoethyl)-3-aminopropyltrimethoxysilane, N-(6-aminohexyl)aminomethyltriethoxysilane, N-(6-aminohexyl)aminopropyltrimethoxysilane, n-(2-aminoethyl)-11-aminoundecyltrimethoxysilane, N-(2-aminoethyl)-3-aminopropylsilanetriol, 3-aminopropyltrimethoxysilane, 3-aminopropyltriethoxysilane, 3-triethoxysilyl-N-(1,3 dimethyl-butylidene) propylamine, N-phenyl-3-aminopropyltrimethoxysilane, N-(vinylbenzyl)-2-aminoethyl-3-aminopropyltrimethoxysilane hydrochloride, 3-(m-aminophenoxy)propyltrimethoxysilane, m-aminophenyltrimethoxysilane, p-aminophenyltrimethoxysilane, aminophenyltrimethoxysilane, 3-aminopropyltris(methoxyethoxyethoxy)silane, 11-aminoundecyltriethoxysilane, 2-(4-pyridylethyl)triethoxysilane, 2-(2-pyridylethyl)trimethoxysilane, N-(3-trimethoxysilylpropyl)pyrrole, 3-aminopropylsilanetriol, (aminoethylaminomethyl)phenethyltrimethoxysilane, 3-ureidopropyltrialkoxysilane, 3-isocyanatepropyltriethoxysilane, and 3-mercaptopropyltrimethoxysilane.

For example, in a case where the silane compound includes Formula 10 above and the curable reactive group includes any one or more in the group consisting of an amine group, a ureide group, and an isocyanate group, the silane compound may include any one or more in the group consisting of N-2-(aminoethyl)-3-aminopropylmethyldimethoxysilane, N-(2-aminoethyl)-3-aminopropylmethyldiethoxysilane, N-(2-aminoethyl)-3-aminoisobutylmethyldimethoxysilane, 4-amino-3,3-dimethylbutylmethyldimethoxysilane, 3-aminopropylmethyldiethoxysilane, and 3-mercaptopropylmethyldimethoxysilane.

For example, in a case where the silane compound includes Formula 11 above and the curable reactive group includes any one or more in the group consisting of an amine group, a ureide group, and an isocyanate group, the silane compound may include any one or more in the group consisting of 1-amino-2-(dimethylethoxysilyl)propane, 3-aminopropyldiisopropylethoxysilane, 3-aminopropyldimethylethoxysilane, and N-(2-aminoethyl)-3-aminoisobutyldimethylmethoxysilane.

For example, the silane compound may be a compound represented by Formula 10 above, where R¹ may be a C, alkyl group, R² may be a curable reactive group, and R″ may be a C, alkyl group. R² may include an epoxy group. For example, the silane compound may be 3-glycidyloxypropyl methyl dimethoxy silane (GPDMS).

Alternatively, for example, the silane compound may be a compound represented by Formula 9 above, R¹ may be a curable reactive group, and R^{I} may be a C, alkyl group. R¹ may include an epoxy group. For example, the silane compound may be 2-(3,4-epoxycyclohexyl)ethyltrimethoxy silane.

The silane compound may further include a compound represented by

Si(OR^{IV})₄ Formula 12 below.

In Formula 12above, R^{IV} each independently include hydrogen or a C, to C₆ alkyl group.

Reacting the silane compound with the vanillic acid to form a repeating unit represented by Formula 1 above may include, for example, mixing the silane compound and the vanillic acid to form a mixture and mixing a catalyst into the mixture.

The catalyst may include any one or more from the group consisting of an acidic catalyst, a basic catalyst, an ion exchange resin and water. The catalyst may be, for example, an ion exchange resin and may include a structure represented by Formula 13 below.

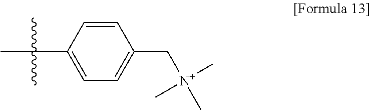 [SMILES: *c1ccc(C[N+](C)(C)C)cc1]

For example, the acidic catalyst may include any one or more from the group consisting of acetic acid, hydrochloric acid, hydrogen fluoride, sulfuric acid, nitric acid, chlorosulfonic acid, iodic acid, and pyrophosphoric acid. The basic catalyst may include, for example, any one or more from the group consisting of potassium hydroxide, sodium hydroxide, barium hydroxide, and imidazole.

Alternatively, reacting the silane compound with the vanillic acid to form the repeating unit represented by Formula 1 above may include, for example, mixing the silane compound with the vanillic acid to form a mixture and stirring the mixture under high temperature conditions.

The stirring of the mixture under high temperature conditions may include, for example, carrying out stirring at about 60° C. to about 150° C., about 70° C. to about 120° C., or about 80° C. to about 100° C.

The stirring of the mixture under high temperature conditions may include, for example, stirring the mixture under a high temperature condition for about 24 hours to about 240 hours, about 30 hours to about 200 hours, about 36 hours to about 160 hours, about 40 hours to about 100 hours, or about 48 hours to about 72 hours.

The reacting of the silane compound with the vanillic acid to form the repeating unit represented by Formula 1 above may include, for example, mixing the silane compound with the vanillic acid to form a mixture, mixing a catalyst into the mixture, and stirring the mixture under high temperature conditions.

The organic-inorganic compound and the curable composition according to the inventive concept makes it possible not only to provide a low carbon and eco-friendly bioplastic solution f but also to improve heat resistance and mechanical characteristics through a silyl ether bond and a silyl ester bond. Ultimately, the organic-inorganic compound and the curable composition according to the inventive concept can be utilized thereby being used in the fields of advanced materials for displays, semiconductors, automobiles, aviation, robots, and the like.

### Example 1

26.8 g of 3-glycidyloxypropyl methyl dimethoxy silane (Sigma-Aldrich Co. LLC), 20.5 g of vanillic acid (Sigma-Aldrich Co. LLC), and 1.2 g of Amberlite IRA-400 (Sigma-Aldrich Co. LLC) were mixed. Thereafter, stirring was carried out at about 80° C. for about 72 hours to produce a compound represented by Formula 14 below.

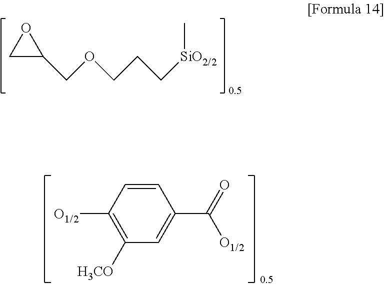

### Example 2

132.2 g of 3-glycidyloxypropyl methyl dimethoxy silane (Sigma-Aldrich Co. LLC), 16.4 g of vanillic acid (Sigma-Aldrich Co. LLC), and 1.0 g of Amberlite IRA-400 (Sigma-Aldrich Co. LLC) were mixed. Thereafter, stirring was carried out at about 100° C. for about 52 hours to produce a compound represented by Formula 15 below.

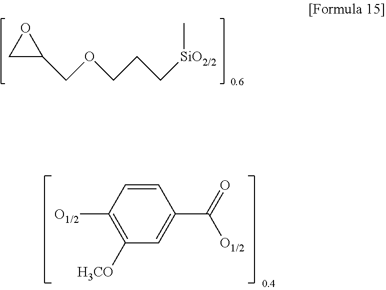

### Example 3

24.9 g of 2-(3,4-epoxycyclohexyl)ethyltrimethoxy silane (Sigma-Aldrich Co. LLC), 25.5 g of vanillic acid (Sigma-Aldrich Co. LLC), and 1.0 g of Amberlite IRA-400 (Sigma-Aldrich Co. LLC) were mixed. Thereafter, stirring was carried out at about 80° C. for about 48 hours to produce a compound represented by Formula 16 below.

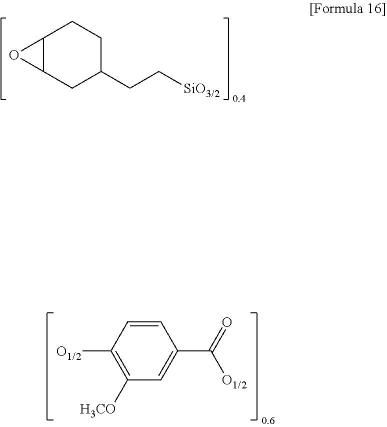

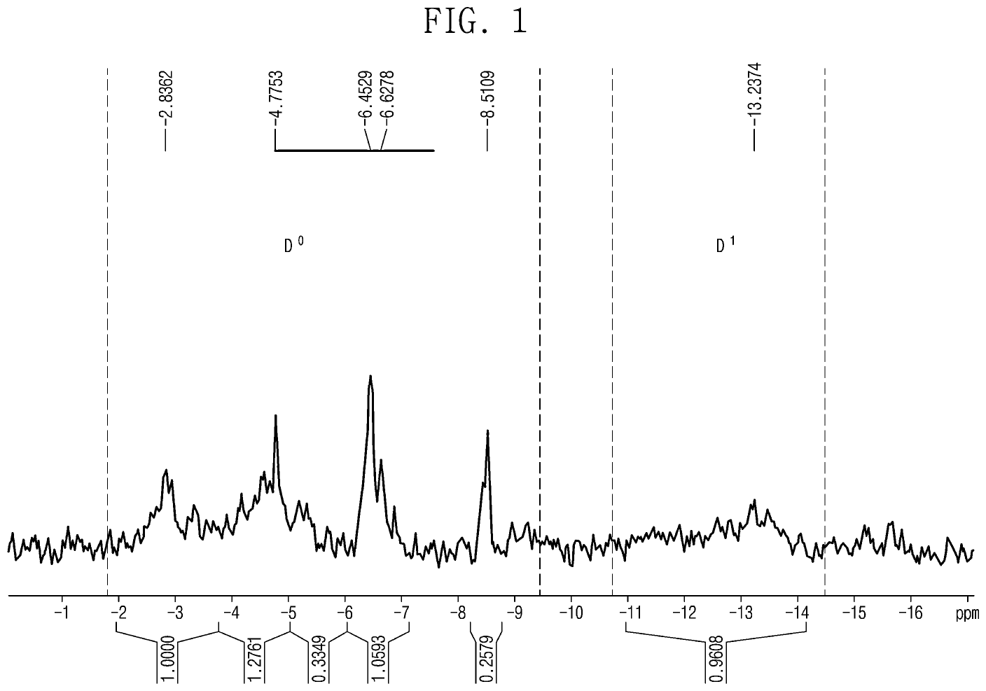

FIG. 1 shows results obtained by carrying out a ²⁹Si-nuclear magnetic resonance (NMR) analysis on <Example 1>.

With reference to FIG. 1, Dⁿ (n=0, 1, or 2) is a general method for representing a siloxane bond, where D indicates that there are two Si—O bonds based on the target Si atom, and n indicates the number of siloxane bonds (Si—O—Si) on the basis of a target Si atom, and n indicates the number of siloxane bonds (Si—O—Si) on the basis of the target Si atom. From FIG. 1, it can be seen that, in <Example 1>, four kinds of the D⁰ type and one kind of the D¹ type are included, and no unresponsive D⁰ type (−1.6 ppm) was detected. Based on this, it can be confirmed that, in <Example>, 3-glycidyloxypropyl methyl dimethoxy silane was reacted with vanillic acid to produce a silyl ether bond and a silyl ester bond.

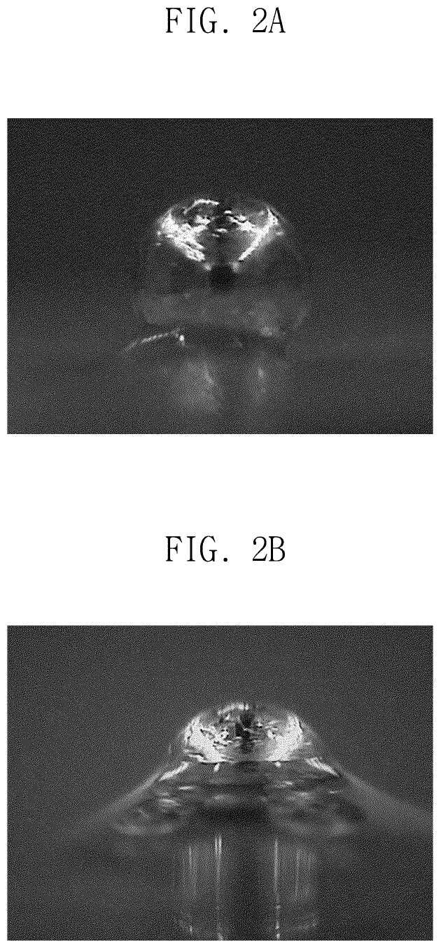

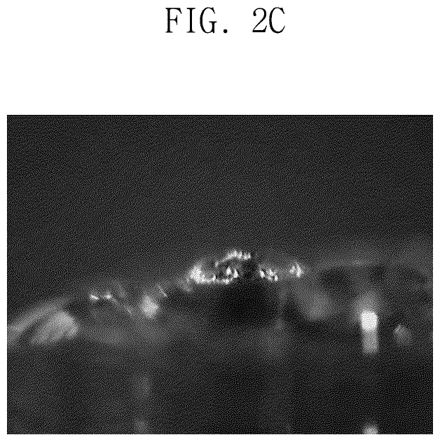

FIG. 2A to FIG. 2C show results of experiments according to <Experimental Example 1>in <Example>.

### Experimental Example 1

The compound according to <Example>was applied onto a copper (Cu) surface, and a SAC305 solder ball was placed thereon. Then, this was put in a high-temperature observation reflow oven and was heated under a temperature rise condition of about 2° C./see, starting at about 21° C. until reaching about 240° C., and then the wettability of the solder was evaluated.

FIG. 2A shows a state of the solder ball at about 21° C. in <Experimental Example 1>. FIG. 2B shows a state of the solder ball at about 220° C. in <Experimental Example 1>. FIG. 2C shows a state of the solder ball at about 230° C. in <Experimental Example 1>.

With reference to FIG. 2A to FIG. 2C, it can be confirmed that the organic-inorganic compound according to <Example 1>has an effect of removing a metal oxide film between the solder ball and the copper, and the solder ball can be wetted on the copper to form a solder joint.

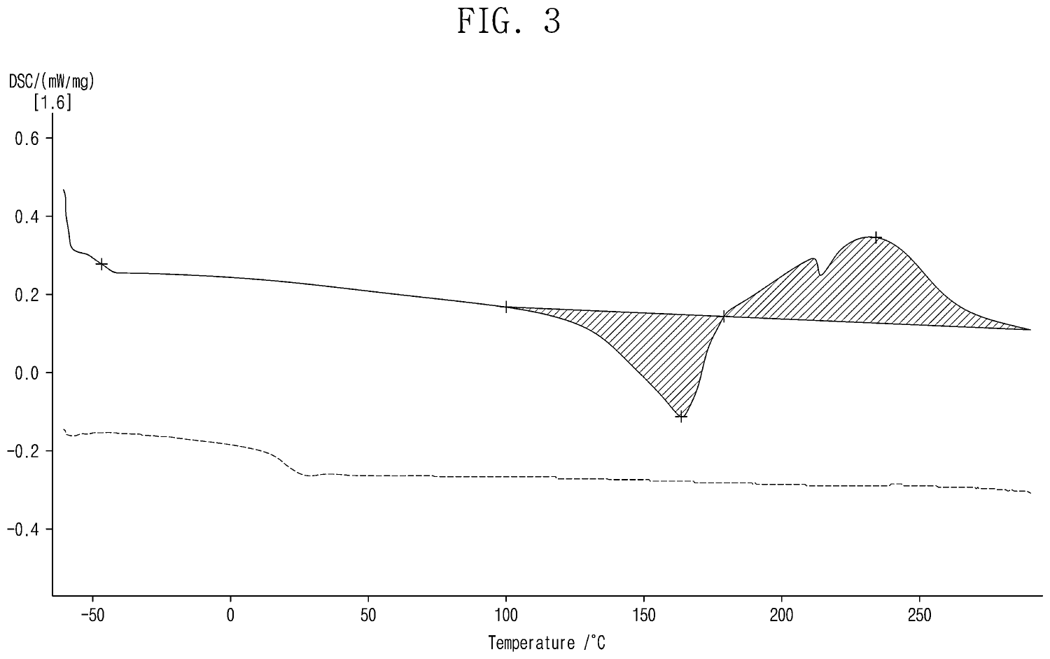

FIG. 3 shows results of an experiment according to <Experimental Example 2>in <Example 1>.

### Experimental Example 2

Heating was carried out for <Example 1>under a temperature rise condition of about 10° C./min, starting at about −60° C. until reaching about 300° C., and then the differential scanning calorimetry (DSC) analysis was carried out twice.

Referring to FIG. 3, the solid line indicates the results of the first DSC analysis in <Example 1>, and the dotted line indicates the results of the second DSC analysis in <Example 1>.

With reference to the results of the first DSC analysis, a glass transition temperature (Tg) before curing was about −46.4° C. It can be confirmed that an endothermic reaction of about 37.4 J/g occurs at about 163.6° C. as the peak temperature, and an exothermic reaction of about 62.1 J/g occurs at about 234.2° C. as the peak temperature. With reference to the results of the second DSC analysis, it can be confirmed that the glass transition temperature (Tg) has risen to about 20.7° C. after the reaction. On the basis of this, it can be confirmed that the compound according to <Example 1>alone can undergo a curing reaction.

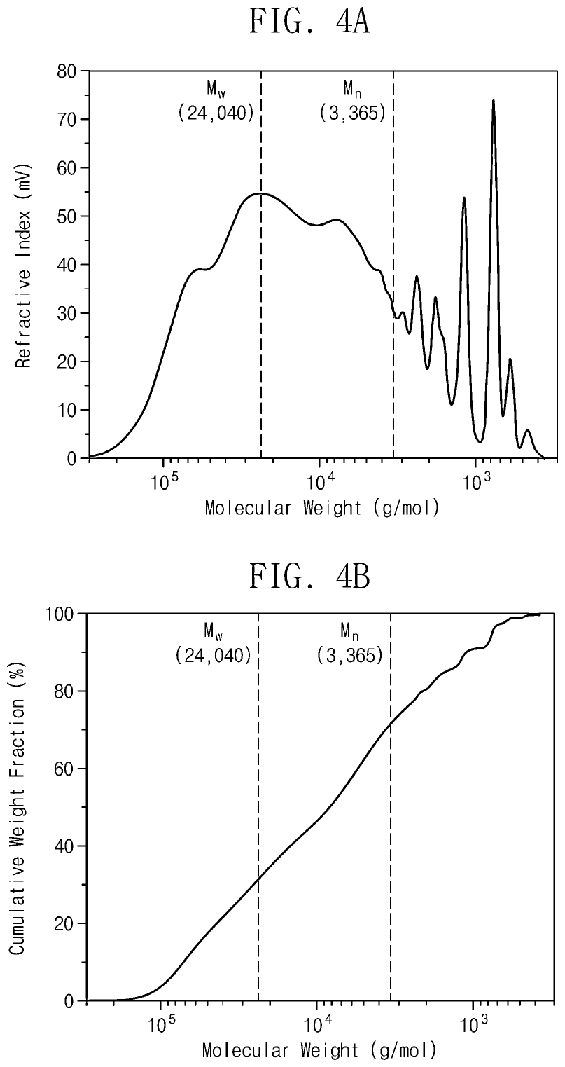

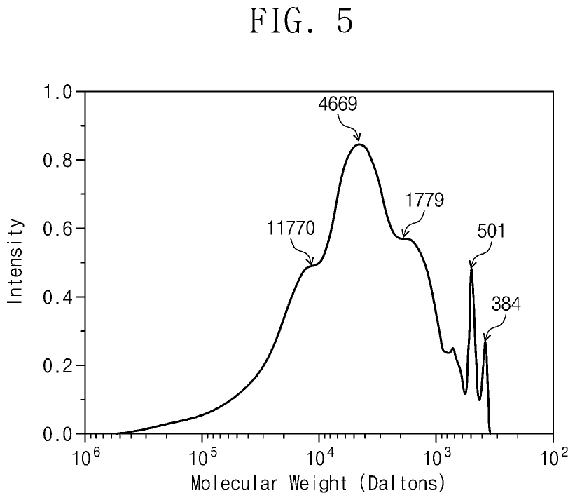

FIG. 4A to FIG. 4B show results of experiments according to <Experimental Example 3>in <Example 2>. FIG. 5 shows results of an experiment according to <Experimental Example 3>in <Example 3>.

### Experimental Example 3

<Example 2>and <Example 3>were subjected to a gel permeation chromatography (GPC) analysis.

FIG. 4A shows the refractive index (mV) in <Example 3>according to the molecular weight (g/mol) in <Experimental Example 2>. FIG. 4B shows the cumulative weight fraction (%) in <Experimental Example 3>according to the molecular weight (g/mol) in <Experimental Example 2>. FIG. 5 shows the intensity in <Experimental Example 3>according to the molecular weight (g/mol) in <Experimental Example 3>.

Referring to FIG. 4A and FIG. 4B, it can be confirmed that the organic-inorganic compound according to <Example 2>includes oligomer-shaped molecules having a number average molecular weight (Mn) of about 3,365 g/mol and a weight average molecular weight (Mw) of about 20,040 g/mol in a molecular weight range of about 500 to about 300,000 g/mol, due to the condensation reaction between 3-glycidyloxypropyl methyl dimethoxy silane and vanillic acid.

Referring to FIG. 5, it was confirmed that the organic-inorganic compound according to <Example 3>includes oligomer-shaped molecules having a number average molecular weight (Mn) of about 2,415 g/mol and a weight average molecular weight (Mw) of about 11,793 g/mol in a molecular weight range of about 400 to about 500,000 g/mol, due to the condensation reaction between 2-(3,4-epoxycyclohexyl)ethyltrimethoxy silane and vanillic acid.

The organic-inorganic compound and the curable composition according to the inventive concept may not only provide a bioplastic solution for low carbon and environmental friendliness but also may improve heat resistance and mechanical characteristics through a silyl ether bond and a silyl ester bond. Ultimately, The organic-inorganic compound and the curable composition according to the inventive concept may be utilized thereby being used in the fields of advanced materials for displays, semiconductors, automobiles, aviation, robots, and the like.

Although the embodiments of the present invention have been described with reference to the attached drawings, the present invention can be implemented in other specific forms without changing the technical ideas or essential features. Therefore, it should be understood that the embodiments described above should be understood as exemplary and be not limited thereto.

What is claimed is:

1. An organic-inorganic compound comprising:
a curable reactive group; and
a structure represented by Formula 1 below:

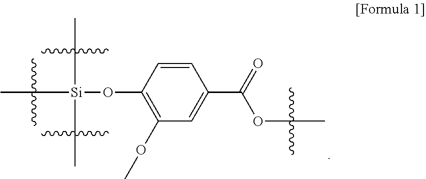 [SMILES: *OC(=O)c1ccc(O[Si](*)(*)*)c(OC)c1]

2. The organic-inorganic compound of claim 1, wherein Formula 1 above is Formula 2 below:

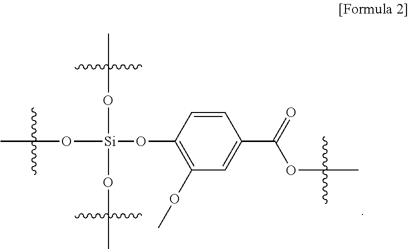

3. The organic-inorganic compound according to claim 1, wherein the Formula in the organic-inorganic compound further includes Formula 3 below:

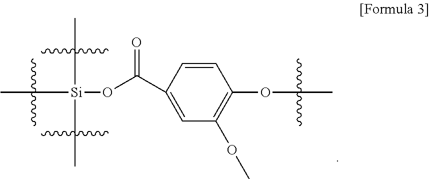 [SMILES: *Oc1ccc(C(=O)O[Si](*)(*)*)cc1OC]

4. The organic-inorganic compound of claim 3, wherein Formula 3 above is Formula 4 below:

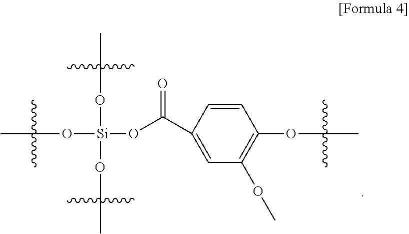 [SMILES: *Oc1ccc(C(=O)O[Si](O*)(O*)O*)cc1OC]

5. The organic-inorganic compound of claim 1, wherein the Formula in the organic-inorganic compound further includes a repeating unit represented by Formula 5 below:

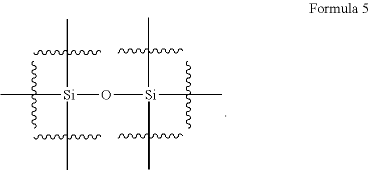

6. The organic-inorganic compound of claim 1, wherein the organic-inorganic compound further includes at least one among the group consisting of a compound represented by Formula 6 below and a compound represented by Formula 7 below: 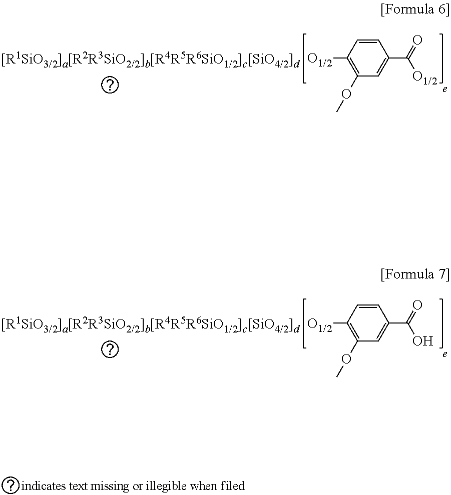
where, in Formula 6 above and Formula 7 above,
a, b, c, and d are each independently 0 or a positive number,
wherein at least one of a, b, or c is a positive number,
e is a positive number,
R¹, R², R³, R⁴, R⁵, and R⁶ are each independently selected from the group consisting of the curable reactive group, a C₁ to C₂₀ alkyl group, a C₃ to C₈ cycloalkyl group, and a C₆ to C₂₀ aryl group, and
at least one of R¹, R², R³, R⁴, R⁵, or R⁶ includes the curable reactive group.

7. The organic-inorganic compound of claim 6, wherein the organic-inorganic compound further includes a compound represented by Formula 8 below: 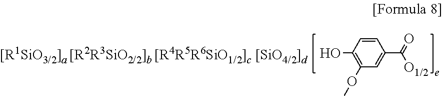
where, in Formula 8 above,
a, b, c, and d are each independently 0 or a positive number, where at least one of a, b, or c is a positive number,
e is a positive number,
R¹, R², R³, R⁴, R⁵, and R⁶ are each independently selected from the group consisting of the curable reactive group, a C₁ to C₂₀ alkyl group, a C₃ to C₈ cycloalkyl group, and a C₆ to C₂₀ aryl group, and
at least one of R¹, R², R³, R⁴, R⁵, or R⁶ includes the curable reactive group.

8. The organic-inorganic compound of claim 7, wherein Formula 6, Formula 7, and Formula 8, above each independently satisfy Expression 1 to Expression 3 below:
$$0.3 \leq a + b + c + d \leq 0.7 \qquad [ Expression 1 ]$$
$$0.3 \leq e \leq 0.7 \qquad [ Expression 2 ]$$
$$a + b + c + d + e = 1. \qquad [ Expression 3 ]$$

9. The organic-inorganic compound of claim 1, wherein the curable reactive group includes any one or more from the group consisting of an epoxy group, an amine group, an acrylic group, a methacrylic group, a mercapto group, a carboxylic group, a vinyl group, a nitro group, a sulfone group, a hydroxy group, a urethane group, a ureide group, an isocyanate group, an oxetane group, and combinations thereof.

10. A production method of an organic-inorganic compound, comprising:
preparing a silane compound containing a curable reactive group;
preparing vanillic acid; and
reacting the silane compound with the vanillic acid to form a repeating unit represented by Formula 1 below:

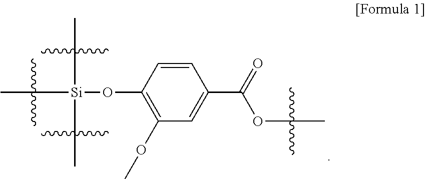

11. The production method of an organic-inorganic compound of claim 10,
wherein the silane compound includes any one or more selected from the group consisting of Formula 9 below to Formula 11 below:
R¹Si(OR)₃ [Formula 9]
R²R³Si(OR^{II})₂ [Formula 10]
R⁴R⁵R⁶Si(OR^{III}) [Formula 11]
where, in Formula 9 above and Formula 11 above,
R¹, R², R³, R⁴, R⁵, and R⁶ are each independently selected from the group consisting of the curable reactive group, a C₁ to C₂₀ alkyl group, a C₃ to C₈ cycloalkyl group, and a C₆ to C₂₀ aryl group,
at least one of R¹, R², R³, R⁴, R⁵, or R⁶ includes the curable reactive group, and
R^{I}, R^{II}, and R^{III} each independently include hydrogen or a C₁ to C₆ alkyl group.

12. The production method of claim 10, wherein the forming of the repeating unit represented by Formula 1 above includes reacting the silane compound with the vanillic acid at a molar ratio of about 1:2.3 to about 2.3:1.

13. The production method for an organic-inorganic compound of claim 10, wherein the silane compound includes any one or more in the group consisting of 5,6-epoxyhexyltriethoxysilane, 3-glycidoxypropyltrimethoxysilane, 3-glycidoxypropyltriethoxysilane, 2-(3,4-epoxycyclohexyl)ethyltrimethoxysilane, 2-(3,4-epoxycyclohexyl)ethyltriethoxysilane, 3-ethyl-3-[[3-(triethoxysilyl)propoxy]methyl]oxetane, 7-trimethoxysilyl-4-thia-heptanoic acid-(3-ethyl-oxetan-3-yl)methyl ester, N-(3-triethoxysilylpropyl)-(3-ethyloxetan-3-yl)-methyl carbamate, 2-(3-triethoxysilylpropylthio)succinic acid-bis-[(3-ethyloxetane-3-yl)-methyl]ester, (3,4-epoxycyclohexyl)ethyldimethoxysilane, 2-(3,4-epoxycyclohexyl)ethyl(methyl)dimethoxysilane, (3,4-epoxycyclohexyl)ethyldiethoxysilane, 2-(3,4-epoxycyclohexyl)ethyl(methyl)diethoxysilane, (2-(7-oxabicyclo[4.1.0]heptan-3-yl)ethyl)(methyl)silanediol, dimethoxy(methyl)(3-(oxiran-2-yl)propyl)silane, diethoxy(methyl)(3-(oxiran-2-yl)propyl)silane, methyl(3-(oxiran-2-yl)propyl)silanediol, (3-glycidoxypropyl)dimethoxymethylsilane, (3-glycidoxypropyl)diethoxymethylsilane, (3-glycidoxypropyl)methylsilanediol, (3-glycidoxypropyl)dimethylethoxysilane, and 3-glycidoxypropyldimethylmethoxysilane.

14. The production method of claim 10, wherein the silane compound includes any one or more in the group consisting of 4-aminobutyltriethoxysilane, 4-amino-3,3-dimethylbutyltrimethoxysilane, N-(2-aminoethyl)-3-aminopropyltrimethoxysilane, N-(6-aminohexyl)aminomethyltriethoxysilane, N-(6-aminohexyl)aminopropyltrimethoxysilane, n-(2-aminoethyl)-11-aminoundecyltrimethoxysilane, N-(2-aminoethyl)-3-aminopropylsilanetriol, 3-aminopropyltrimethoxysilane, 3-aminopropyltriethoxysilane, 3-triethoxysilyl-N-(1,3 dimethyl-butylidene) propylamine, N-phenyl-3-aminopropyltrimethoxysilane, N-(vinylbenzyl)-2-aminoethyl-3-aminopropyltrimethoxysilane hydrochloride, 3-(m-aminophenoxy)propyltrimethoxysilane, m-aminophenyltrimethoxysilane, p-aminophenyltrimethoxysilane, aminophenyltrimethoxysilane, 3-aminopropyltris(methoxyethoxyethoxy)silane, 11-aminoundecyltriethoxysilane, 2-(4-pyridylethyl)triethoxysilane, 2-(2-pyridylethyl)trimethoxysilane, N-(3-trimethoxysilylpropyl)pyrrole, 3-aminopropylsilanetriol, (aminoethylaminomethyl)phenethyltrimethoxysilane, 3-ureidopropyltrialkoxysilane, 3-isocyanatopropyltriethoxysilane, 3-mercaptopropyltrimethoxysilane, N-(2-aminoethyl)-3-aminopropylmethyldimethoxysilane, N-(2-aminoethyl)-3-aminopropylmethyldiethoxysilane, N-(2-aminoethyl)-3-aminoisobutylmethyldimethoxysilane, 4-amino-3,3-dimethylbutylmethyldimethoxysilane, 3-aminopropylmethyldiethoxysilane, 3-mercaptopropylmethyldimethoxysilane, 1-amino-2-(dimethylethoxysilyl)propane, 3-aminopropyldiisopropylethoxysilane, 3-aminopropyldimethylethoxysilane, and N-(2-aminoethyl)-3-aminoisobutyldimethylmethoxysilane.

15. The production method of claim 10,
wherein the forming of the repeating unit represented by Formula 1 above includes mixing the silane compound with the vanillic acid to form a mixture and mixing a catalyst into the mixture,
where the catalyst includes any one or more from the group consisting of an acidic catalyst, a basic catalyst, an ion exchange resins and water,
the acidic catalyst includes any one or more from the group consisting of acetic acid, hydrochloric acid, hydrogen fluoride, sulfuric acid, nitric acid, chlorosulfonic acid, iodic acid, and pyrophosphoric acid, and
the basic catalyst includes any one or more selected from the group consisting of potassium hydroxide, sodium hydroxide, barium hydroxide, and imidazole.

16. The production method of claim 15, wherein the catalyst is an ion exchange resin including a structure represented by Formula 13 below:

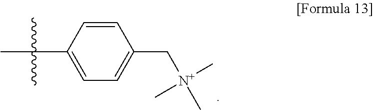 [SMILES: *c1ccc(C[N+](C)(C)C)cc1]

17. A curable composition comprising:
an organic-inorganic compound containing a curable reactive group and including a structure represented by Formula 1 below; and
a curing agent,
wherein the curing agent includes any one or more from the group consisting of an acid anhydride-based curing agent, an amine-based curing agent, an imidazole-based curing agent, a carboxylic acid-based curing agent, a phosphine-based curing agent, and a urea derivative-based curing agent:

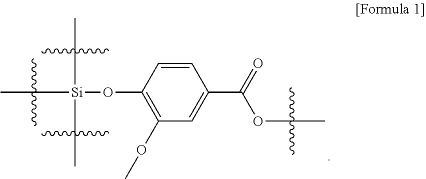 [SMILES: *OC(=O)c1ccc(O[Si](*)(*)*)c(OC)c1]

18. The curable composition of claim 17, wherein the curable composition further contains an initiator, and
the initiator includes any one or more from the group consisting of a photoacid generator, a photobase generator, and a thermal acid generator.

19. The curable composition of claim 17, further comprising a reactive diluent,
wherein, the reactive diluent includes any one or more from the group consisting of an epoxy reactive diluent, an oxetane reactive diluent, and polyethylene glycol.

20. The curable composition of claim 17, further comprising an additive, wherein the additive includes any one or more from the group consisting of a carbon nanotube, a fullerene, hexagonal boron nitride, a boron nitride nanotube, alumina, a metal particle, a solder particle, and MXene.
